(19) United States
(12) Patent Application Publication
(10) Pub. No.: US 2002/0178284 A1
(43) Pub. Date: Nov. 28, 2002

(54) Intelligent transport agent for transmitting data

(75) Inventors: Kevin R. Alexander, Cambridge (CA); Paul Lansing, Orangeville (CA)

Correspondence Address: Bhupinder Randhawa, Bereskin & Parr, 40 King Street West, Box 401, Toronto, ON, M5H 3Y2, CA

(73) Assignee: Lanux Limited

(21) Appl. No.: 09/864,245

(22) Filed: May 25, 2001

(51) Int. Cl. G06F 15/16

(52) U.S. Cl. 709/236

(57) ABSTRACT

This invention provides a message format and a method for the delivery of message data from a transmitting computer in a first environment to a receiving computer in a second environment. The transmitting computer prepares a message which includes message data, a delivery wrapper and a presentation wrapper. The delivery wrapper includes a delivery agent and a list of presentation software and presentation data components which may be required for a user to access the message data on the receiving computer. The presentation software and presentation data components are included in the presentation wrapper of the message. The message is transmitted from the first computer to the second computer by a transmitting agent operating on the first computer, beginning with the delivery wrapper. The delivery agent is activated on the receiving computer once it is received and it determines which of the presentation software and presentation data components must be added to the second environment in order for the message data to be viewed or manipulated. The delivery agent then instructs the transmitting agent not to send presentation software and presentation data components which already exist on the receiving computer or which are not otherwise required. The delivery agent then creates a presentation environment which may incorporate presentation software and presentation data components software that previously existed in the second environment as well as newly added components allowing the user of the second computer to access the message data. The newly added components may or may not be retained as part of the second environment.

### FIELD OF THE INVENTION

This invention relates to data messages. More particularly, this invention relates to a message structure and method for allowing data to be used in different computing environments.

### BACKGROUND OF THE INVENTION

In modern computing and business environments, it is often convenient for one person to send data to another person in an electronic format. Computer based data is often recorded in a format that is specific to the environment in which it was created. Among other factors, this environment may include the software application with which the data was created and the operating system used to operate the computer running the software application. When such data is sent from one computer to another, it is encoded in a message format that includes only the data. When such a message is sent to a computer with a different operating system or which does not have a copy of the software application (or an equivalent application) installed on it, the data cannot be used at the receiving computer.

Accordingly, there is a need for a message structure that allows data to be transmitted from one computer to a second computer which has a different environment than the first computer and that allows the data to be used on the second computer.

### SUMMARY OF THE INVENTION

The invention provides a message format that includes message data , a delivery wrapper and a presentation wrapper. Typically, the message data will have been created on a transmitting computer with a first environment. The delivery wrapper includes a delivery agent and list of presentation software and presentation data components required for a user to access the message data on a receiving computer which may have a different environment. When the message is sent from the transmitting computer to the second computer by a transmitting agent, the delivery agent determines which of the presentation software and presentation data components encoded in the presentation wrapper are required to allow access to the message data on the receiving computer. The delivery agent then instructs the transmitting agent not to send presentation software and presentation data components which already exist on the receiving computer. The delivery agent then creates a presentation environment incorporating presentation software and presentation data components from the presentation wrapper, allowing the user to access the message data.

### BRIEF DESCRIPTION OF THE DRAWINGS

The present invention will now be explained by way of example only with reference to the drawings, in which:

FIG. 1 illustrates a message according to the present invention;

FIG. 2 illustrates the transmission of the message of FIG. 1 from a transmitting computer to a receiving computer

FIGS. 3 and 4 are flowcharts of a method for transmitting the message of FIG. 1 according to the present invention; and

FIG. 5 is a flowchart of a method for receiving the message of FIG. 1 according to the present invention.

### DETAILED DESCRIPTION OF THE PREFERRED EMBODIMENT

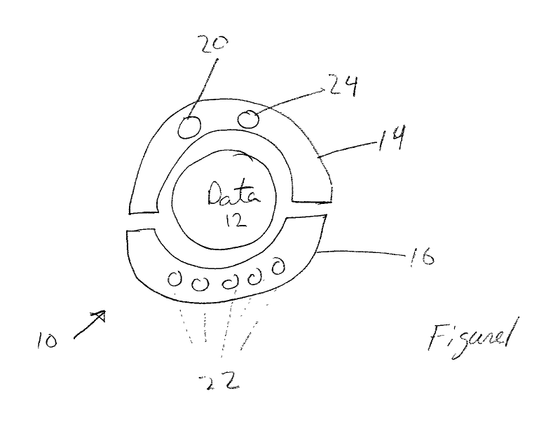

Reference is first made to FIG. 1, which illustrates a message 10 structured according to the present invention.

Message 10 includes message data 12, a delivery wrapper 14 and a presentation wrapper 16. Presentation wrapper 16 contains presentation software and presentation data components 22. Delivery wrapper 14 includes delivery agent 20 and a list 24 of presentation software and presentation data components 22.

Message data 12 may be any type of electronic data. For example, message data 12 may be a data file for a commercially available spreadsheet or word processing program. Message data 12 may include security means for ensuring that message data 12 is access only by authorized persons, on an authorized computer, etc.

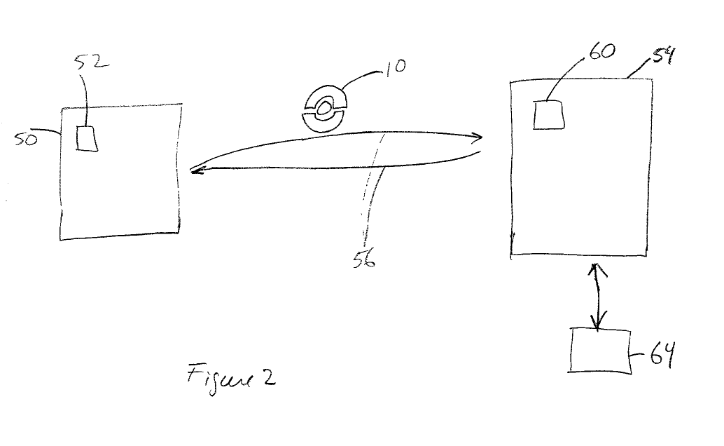

Reference is next made to FIG. 2, which illustrates a message 10 being transmitted from a transmitting computer 50 to a receiving computer 54. A transmitting agent 52 operating on transmitting computer 50 forms message 10 and transmits it on a transmission medium 56. A receiving agent 60 operating on receiving computer 54 receives message 10 and presents message data 12 (FIG. 1) to a user 64 of receiving computer 54. As message 10 is received at receiving computer 58, delivery agent 20 (FIG. 1), which is part of delivery wrapper 14 (FIG. 1), is executed. Delivery agent 20 may transmit “Component Not Required” messages 68 (“CNR messages”) to transmitting agent 52 via transmission medium 56.

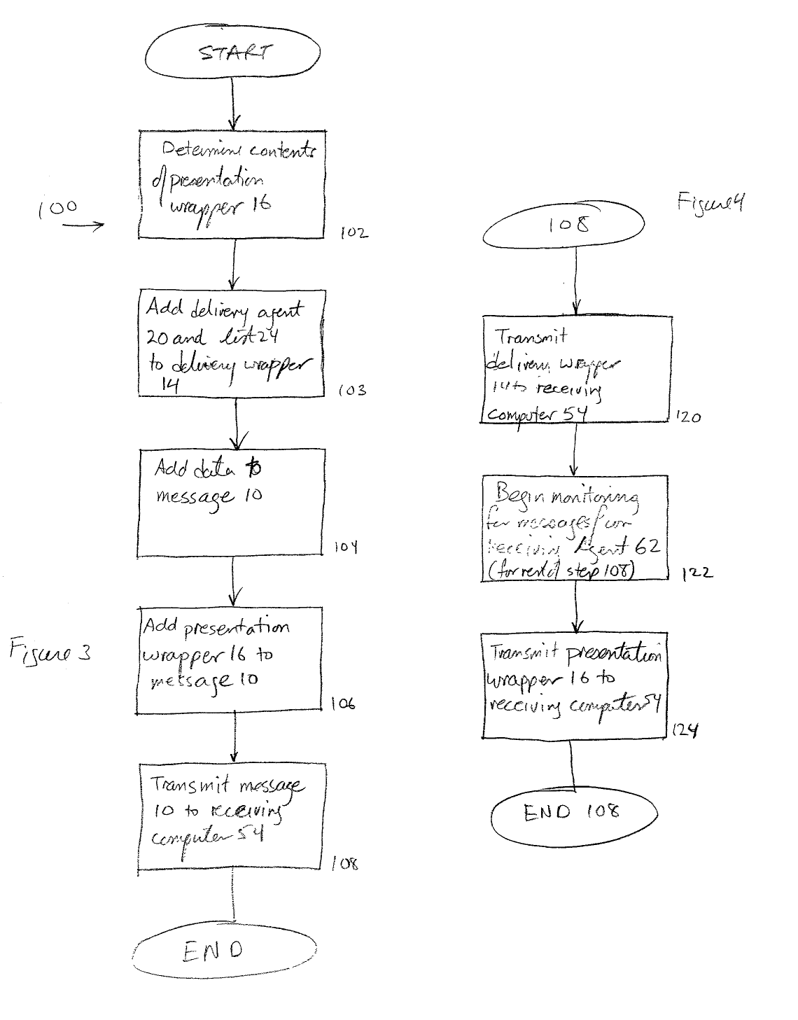

Reference is next made to FIG. 3, which shows a method 100 by which message 10 is formed and then sent from transmitting computer 50 to receiving computer 54. Method 100 is performed on transmitting computer 50.

Method 100 starts in step 102. In step 102, transmitting agent 52 determines the contents of presentation wrapper 16. Transmitting agent 52 examines message data 12 to determine what presentation software or presentation data components 22 may be required by a user to access message data 12 on receiving computer 54. For example, if message data 12 is a presentation which requires word processing software, spreadsheet software and a database to be present on receiving computer 54, then these pieces of presentation software and presentation data will form components 22.

Method 100 next proceeds to step 103, in which transmitting agent 52 adds delivery agent 20 and a list 24 of components 22 to message 10 as part of delivery wrapper 14. Delivery agent 20 is executable on receiving computer 54.

Method 100 then proceeds to step 104. In step 104, transmitting agent 52 adds message data 12 to message 10.

Method 100 then proceeds to step 106. In step 106, transmitting agent 52 adds presentation wrapper 16 to message 10. Presentation wrapper 16 comprises presentation software and presentation data components 22 selected in step 102.

Method 100 then proceeds to step 108. In step 108, transmitting agent 52 begins to transmit message 10 to receiving computer 54. The different parts of message 10 are preferably transmitted in the same order in which they were added to message 10: delivery agent 14, data 10 and presentation wrapper 16.

Reference is next made to FIG. 4, which illustrates step 108 in greater detail, starting in step 120.

In step 120, transmitting agent 52 transmits delivery wrapper 14 to receiving computer 54. As mentioned above and explained in further detail below, delivery agent 20 will be executed on receiving computer 54 after delivery wrapper 14 has been received.

Method 100 next proceeds to step 122. In step 122, transmitting agent 52 starts monitoring transmission line 56 for CNR messages 68 from delivery agent 20. Transmitting agent 52 continues to monitor transmission line 56 for such CNR messages 68 for the remainder of step 108. If any such CNR message 68 is received from delivery agent 20, the CNR message 68 is stored.

Method 100 next proceeds to step 124. In step 124, transmitting agent 52 sends presentation software and presentation data components 22, one at a time, to receiving computer 54, subject to instructions received from delivery agent 20. Before any particular piece of software (such as the word processing application or spreadsheet application selected in step 102) or data (such as the database selected in step 102) is transmitted, transmitting agent 52 checks all CNR messages 68 received from delivery agent 20 to determine if delivery agent 20 has indicated that the particular software or data is not required. If such a CNR message 68 has been received, transmitting agent 52 does not send the software or data and moves on to a consideration of the next piece of software or data, if any. If such a CNR message 68 has not been received, then the piece of software or data is transmitted to receiving computer 54. If during the transmission of a particular piece of presentation software or presentation data, a CNR message 68 is received from delivery agent 20 that the software or data is not required, the transmission is terminated and transmitting agent moves on to consider the next piece of software or data, if any. Step 122 ends when all presentation software and presentation data which are part of presentation software and presentation data components 22 have been transmitted or skipped in this manner.

Method 100 ends when step 122 is complete.

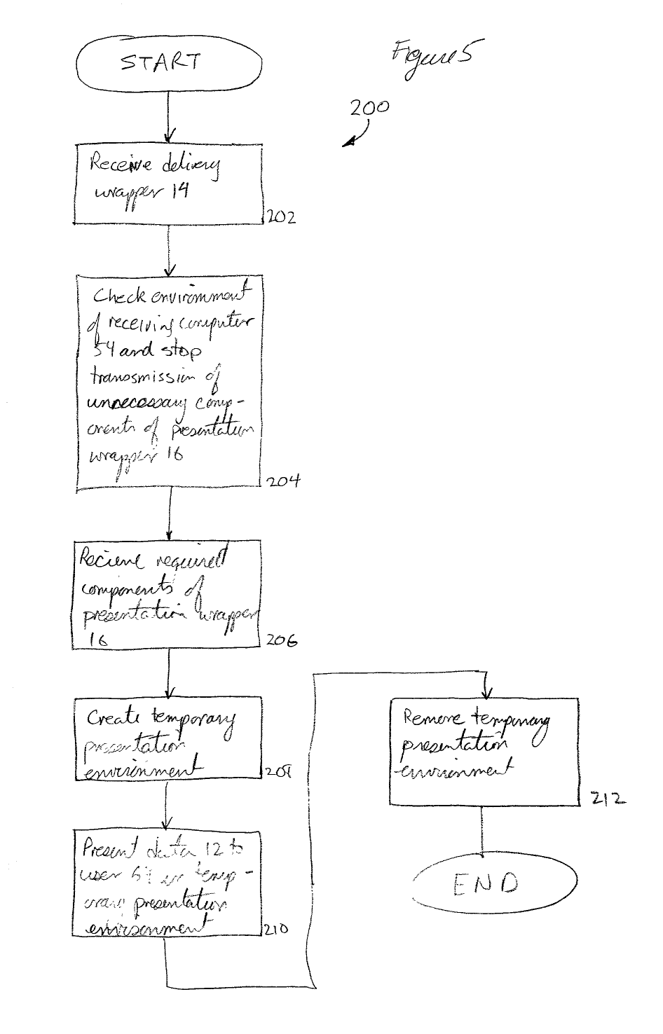

Reference is next made to FIG. 5, which illustrates a method 200 by which message 10 is received at receiving computer 54 and by which message data 12 is presented to a user of receiving computer 54.

Method 200 begins in step 202, in which a receiving agent 62 operating on receiving computer 54 begins to receives message 10. Receiving agent 54 receives message 10 in the same order in which it is transmitted by transmitting agent 52. Step 202 ends when delivery wrapper 14 has been received. (One skilled in the art will recognize that message 10 will be received continuously throughout this and the following steps until it has been received in its entirety (subject to the following steps).)

Method 200 then proceeds to step 204, in which receiving agent 62 initiates the execution of delivery agent 20. Delivery agent 20 checks the environment of receiving computer 54 to determine whether any of the presentation software or presentation data components 22 required for message data 12 to be accessed on receiving computer 54 already exist on receiving computer 54. Delivery agent 20 then sends a CNR message 68 to transmitting agent 52 operating on transmitting computer 50 indicating that such components 22 need not be transmitted as part of message 10. For example, if the spreadsheet software identified in step 102 already exists on receiving computer, delivery agent 20 will send a CNR message 68 to transmitting agent 52 indicating that the spreadsheet software should not be sent as part of message 10.

Method 200 then proceeds to step 206, in which receiving agent 54 receives the remainder of message 10, excluding the components 22 skipped by transmitting agent 52 in step 110. Step 206 end when receiving agent has received all of the components 22 of presentation wrapper 16 which do not already exist on receiving computer 54.

Method 200 next proceeds to step 208. In step 208, delivery agent 20 creates a temporary presentation environment 64 that includes all presentation software and presentation data required to access message data 12. This may include presentation software and presentation data components 22 received as part of message 10 or equivalent components previously available on receiving computer 54. Step 208 may be delayed until a user 66 of receiving computer 54 initiates step 208.

Method 200 next proceeds to step 210, in which user 66 of receiving computer 54 may access message data 12 utilizing temporary presentation environment 64. Step 210 ends when user 66 indicates that he or she no longer requires access to message data 12.

Method 200 next proceeds to step 212, in which temporary presentation environment 64 is removed from receiving computer 54.

Method 200 then ends.

The result of methods 100 and 200 is that message data 12 is transmitted from transmitting computer 50 to receiving computer 54 along with presentation software and presentation data components required to allow user 64 to access message data 12 on receiving computer 54. Presentation software and presentation data components which already exist on the receiving computer may not be transmitted, if delivery agent 20 is able to determine that they are needed in time to stop transmitting agent from sending them.

Many variations of this invention are possible. For example, message 10 may be modified to include security information to prevent reception of message 10 at an unauthorized computer or to prevent an unauthorized user from accessing message data 12. In addition, the presentation environment created in step 208 may be a permanent presentation environment. Presentation software and presentation data components transmitted as part of presentation wrapper 16 of message 10 may be permanently added to the environment of receiving computer 54, allowing user 64 to access message data 12 repeatedly without having to reinstall the necessary presentation software and presentation data components each time. Permanent installation of presentation software and presentation data components 22 is particularly useful where these components 22 are open source or other public domain items, which can be freely distributed.

In another variation, delivery wrapper 14 and presentation wrapper 16 may be compatible with several different environments which might be operating on one or more receiving computers to which message 10 might be sent. In this case, more than one delivery agent 20 may be included in delivery wrapper 14 and different versions of presentation software and presentation data components may be included in presentation wrapper 16.

In another variation, delivery agent 20 may be omitted. Receiving agent 62 may be configured to examine list 24 of presentation software and presentation data components 22 to determine which of them (or an equivalent) is available on receiving computer 54. Receiving agent 62 may then send a CNR message in step 122 in the place of delivery agent 20.

These and other variations fall within the scope of this invention.

We claim:

1. A method of transmitting a message to a receiving computer comprising:
(a) forming said message by
(i) forming a delivery wrapper as part of said message;
(ii) adding message data to said message; and
(iii) adding a presentation wrapper to said message, wherein said presentation wrapper comprises one or more components;
(b) transmitting said delivery wrapper to said receiving computer;
(c) transmitting said data to said receiving computer;
(d) selectively transmitting said components of said presentation wrapper to said receiving computer by:
(i) selecting one of said components;
(ii) transmitting said selected component unless a CNR message relating to said component has been received; and
(iii) repeating steps (d)(i) and (d)(ii) for each of said components.

2. The method of claim 1 wherein said delivery wrapper comprises a list of said components.

3. The method of claim 1 wherein said components comprises presentation software and presentation data.

4. The method of claim 2 wherein said delivery wrapper further comprises a delivery agent executable on said receiving computer.

5. The method of claim 2 wherein said delivery wrapper further comprises a first delivery agent and a second delivery agent wherein said first and second delivery agents are executable on computers with different environments.

6. The method of claim 1 wherein, during step (d)(ii), if a CNR message relating to said selection component is received while said selected component is being transmitted, the transmission of said selected component is terminated.

7. A method of receiving a message at a receiving computer, wherein said message is transmitted from a transmitting computer comprising:
(a) receiving a delivery wrapper associated with said message, wherein said delivery wrapper contains a list of components;
(b) selecting one of said components;
(c) determining whether said selected component is available on said receiving computer;
(d) if said selected component is determined to be available in step (c), then transmitting a CNR message to said transmitting computer, wherein said CNR message indicates that said selected component need not be transmitted to said receiving computer; and
(e) repeating steps (b), (c) and (d) for each the remaining components in said list of components.

8. The method of claim 7 wherein further comprising:
(f) receiving message data associated with said message; and
(g) receiving one or more of said components;

9. The method of claim 7 wherein said components include presentation software and presentation data.

10. The method of claim 7 wherein, in step (c), if an equivalent of said selected components is determined to be available, then said component is deemed to be available.

11. The method of claim 7 wherein said delivery wrapper includes a delivery agent and steps (b) to (e) are performed by said delivery agent.

12. The method of claim 8 further comprising:
(h) presenting said message data on said receiving computer, using said one or more components received in step (g).

13. The method of claim 12 wherein step (h) is performed by utilizing one or more components determined to be available on said receiving computer in accordance with step (c).
